(19) United States
(12) Patent Application Publication
(10) Pub. No.: US 2024/0281130 A1
(43) Pub. Date: Aug. 22, 2024

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: KOKI SHIRAISHI, Kanagawa (JP)

(21) Appl. No.: 18/582,152

(22) Filed: Feb. 20, 2024

(30) Foreign Application Priority Data
Feb. 22, 2023 (JP) 2023-025858

(51) Int. Cl. G06F 3/0486; H04N 1/00

(52) U.S. Cl. CPC G06F 3/0486; H04N 1/00424

(57) ABSTRACT

An information processing apparatus having a plurality of functions includes a display unit configured to display a predetermined area where a software key indicating any one of the plurality of functions is arrangeable, an acceptance unit configured to accept a first operation for selecting the predetermined area where the software key is not arranged and a second operation for selecting a destination of the predetermined area where the software key is not arranged and selected through the first operation, and a relocation unit configured to relocate the predetermined area where the software key is not arranged and selected through the first operation, to the destination selected through the second operation.

### BACKGROUND

### Field

The present disclosure relates to an information processing apparatus, a control method, and a storage medium.

### Description of the Related Art

An information processing apparatus such as a smartphone displays contents having predetermined functions on a screen. Further, a technique which allows a user to adjust layout to change positions of the contents displayed on a screen of the smartphone has been known (Japanese Application Patent Laid-Open No. 2020-88440).

Furthermore, there has been a demand for improved operability in adjustment of layout of the contents displayed on a screen of the information processing apparatus.

### SUMMARY

According to an aspect of the present disclosure, an information processing apparatus having a plurality of functions includes a display unit configured to display a predetermined area where a software key indicating any one of the plurality of functions is arrangeable, an acceptance unit configured to accept a first operation for selecting the predetermined area where the software key is not arranged and a second operation for selecting a destination of the predetermined area where the software key is not arranged and selected through the first operation, and a relocation unit configured to relocate the predetermined area where the software key is not arranged and selected through the first operation, to the destination selected through the second operation.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an image processing apparatus according to a present exemplary embodiment.

FIG. 2 is a schematic diagram of an operation unit according to the present exemplary embodiment.

FIG. 3A is a diagram illustrating screen transition caused by layout change processing.

FIG. 3B is a diagram illustrating screen transition caused by the layout change processing.

FIG. 3C is a diagram illustrating screen transition caused by the layout change processing.

FIG. 3D is a diagram illustrating screen transition caused by the layout change processing.

FIG. 3E is a diagram illustrating screen transition caused by the layout change processing.

FIG. 3F is a diagram illustrating screen transition caused by the layout change processing.

FIG. 4A is a diagram illustrating screen transition caused by the layout change processing.

FIG. 4B is a diagram illustrating screen transition caused by the layout change processing.

FIG. 4C is a diagram illustrating screen transition caused by the layout change processing.

FIG. 4D is a diagram illustrating screen transition caused by the layout change processing.

FIG. 4E is a diagram illustrating screen transition caused by the layout change processing.

FIG. 4F is a diagram illustrating screen transition caused by the layout change processing.

FIG. 5 is an information table illustrating display positions of application buttons.

FIG. 6 is a flowchart illustrating the layout change processing.

FIGS. 7A to 7F are diagrams illustrating screen transition caused by the layout change processing.

FIG. 8 is a flowchart illustrating the layout change processing.

### DESCRIPTION OF THE EMBODIMENTS

Hereinafter, exemplary embodiments of the present disclosure will be described with reference to the appended drawings. Further, the embodiments described hereinafter are not intended to limit the content of the present disclosure described in the appended claims, and not all of the combinations of features described in the exemplary embodiments are essentially required as the solutions of the present disclosure.

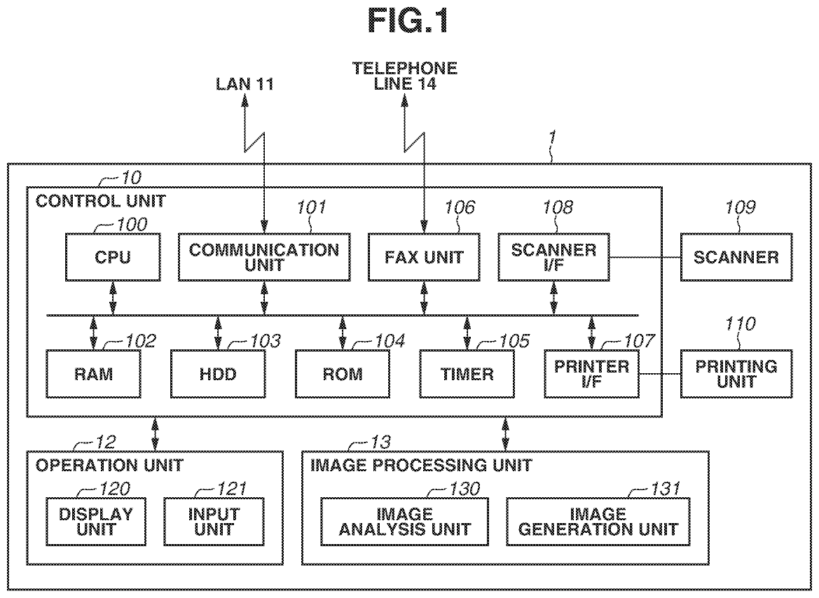

FIG. 1 is a block diagram illustrating a configuration of an image processing apparatus 1 described as one example of the information processing apparatus according to a first exemplary embodiment of the present disclosure. For example, the image processing apparatus 1 is a printer serving as a multifunction peripheral (MFP) having the functions described below. The image processing apparatus 1 does not have to be the MFP, and can be a printer serving as a single function peripheral (SFP). In addition, a printing method of the image processing apparatus 1 can be an electrophotographic printing method, an ink-jet printing method, or other printing methods. Further, the information processing apparatus does not have to be the image processing apparatus, and can be another apparatus such as a personal computer (PC), a tablet terminal, or a smartphone.

The image processing apparatus 1 includes a control unit 10, an operation unit 12, an image processing unit 13, a scanner 109, and a printing unit 110. The control unit 10 controls the operations of respective units of the image processing apparatus 1. The control unit 10 includes a central processing unit (CPU) 100, a communication unit 101, a random access memory (RAM) 102, a hard disk drive (HDD) 103, a read-only memory (ROM) 104, a timer 105, a fax unit 106, a scanner interface (I/F) 108, and a printer I/F 107.

The CPU 100 controls the entirety of the control unit 10. The RAM 102 functions as a work memory of the CPU 100. The HDD 103 stores application programs and image data. The HDD 103 may be a storage medium such as an optical medium or a flash memory. The ROM 104 stores a program such as a boot program read by the CPU 100. The HDD 103 may be provided as an external storage device attachable to and detachable from the image processing apparatus 1. The timer 105 manages time, and the CPU 100 refers to the timer 105 to acquire time information.

The communication unit 101 is connected to a local area network (LAN) 11 and controls data transmission/reception executed via the LAN 11. The fax unit 106 is connected to a telephone line 14 and controls data transmission/reception executed via the telephone line 14.

The operation unit 12 includes a display unit 120 to which a touch panel sheet is attached and an input unit 121 such as a hardware key. The operation unit 12 displays a screen and accepts the operation performed by a user.

In the present exemplary embodiment, a liquid crystal display is described as an example of the display unit 120. However, the display unit 120 may be a display of another type. In the present exemplary embodiment, a touch panel is described as an example of the input unit 121. However, the operation performed by the user may be accepted by another interface such as a mouse.

The image processing unit 13 is controlled by the control unit 10, and includes an image analysis unit 130 and an image generation unit 131. The image analysis unit 130 analyzes a structure of a document image and extracts necessary information from the analysis result. The image generation unit 131 generates image data by reading a document and digitizing an image of the document through the scanner 109. The generated image data is stored in the HDD 103. The image generation unit 131 can also generate document image data of another format by using the information analyzed by the image analysis unit 130.

The image processing apparatus 1 has a copy function, a scan function, and a print function. The copy function is a function which allows the image processing apparatus 1 to read document image data through the scanner 109 and to print an image on a sheet through the printing unit 110 based on the read document image data. The scan function is a function which allows the image processing apparatus 1 to transmit image data the scanner 109 has generated by reading a document image, through the communication unit 101. The print function is a function which allows the image processing apparatus 1 to print an image on a sheet through the printing unit 110 based on print data received from an information processing apparatus such as an external PC via the communication unit 101.

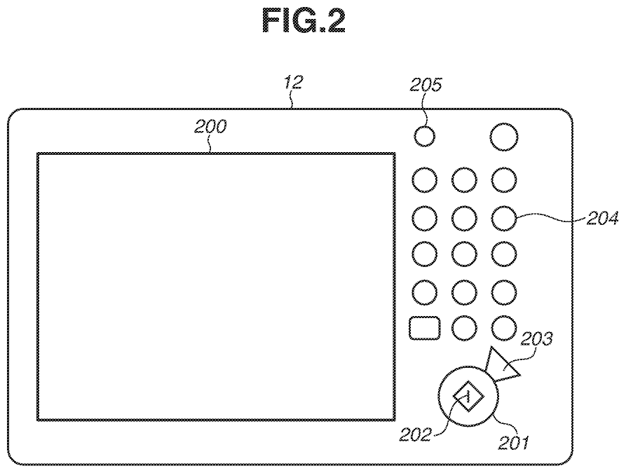

FIG. 2 is a schematic diagram of the operation unit 12 in FIG. 1.

Herein, a touch panel 200 is a liquid crystal display on which a touch panel sheet is attached. The touch panel 200 displays an operation screen and objects such as software keys, and transmits positional information of a displayed object to the CPU 100 when the object is selected by a pointer such as a user's finger. With this configuration, the CPU 100 can determine which object is selected by the user. Accordingly, in this case, the touch panel 200 functions as the display unit 120 as well as the input unit 121 illustrated in FIG. 1. In the present exemplary embodiment, although a constituent element having the function of the touch panel 200 is described as the display unit 120, the display unit 120 does not have to have the function of the touch panel 200. For example, the display unit 120 may display a screen shifted through an operation of a cursor performed via a pointing device such as a mouse.

Next, various keys and buttons operated by the user will be described. A start key 201 is used when the user inputs an instruction to start reading a document by the scanner 109.

The start key 201 has a light emitting diode (LED) 202 for emitting light of two colors, green and red, at a central part thereof, and a usable/non-usable state of the start key 201 is indicated by the colors. A stop key 203 is used for stopping the operation that is being executed. A numeric keypad 204 includes numeric keys and symbol keys. The numeric keypad 204 is used when the user sets the number of copies and/or inputs an instruction for changing a screen displayed on the touch panel 200. A user mode key 205 is used for calling a user mode. In the user mode, the user performs setting of the image processing apparatus 1.

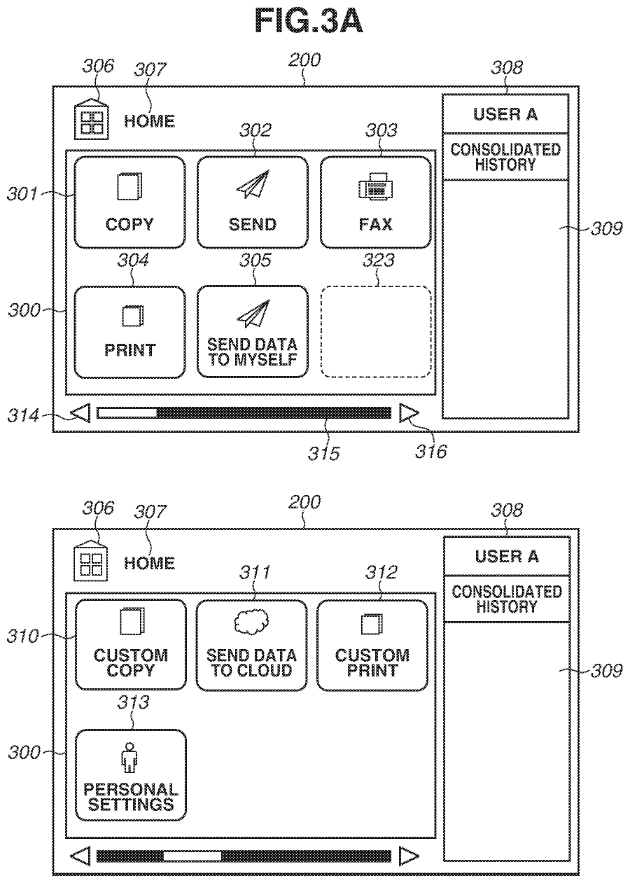

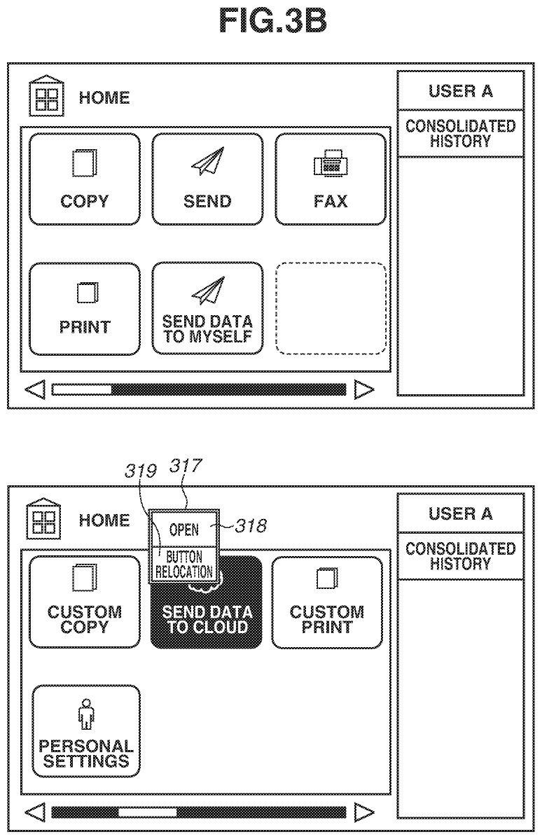

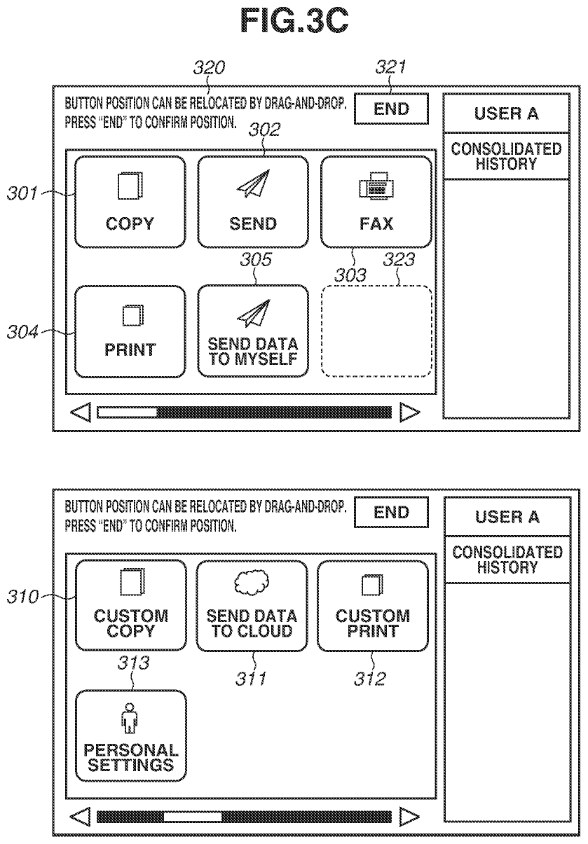

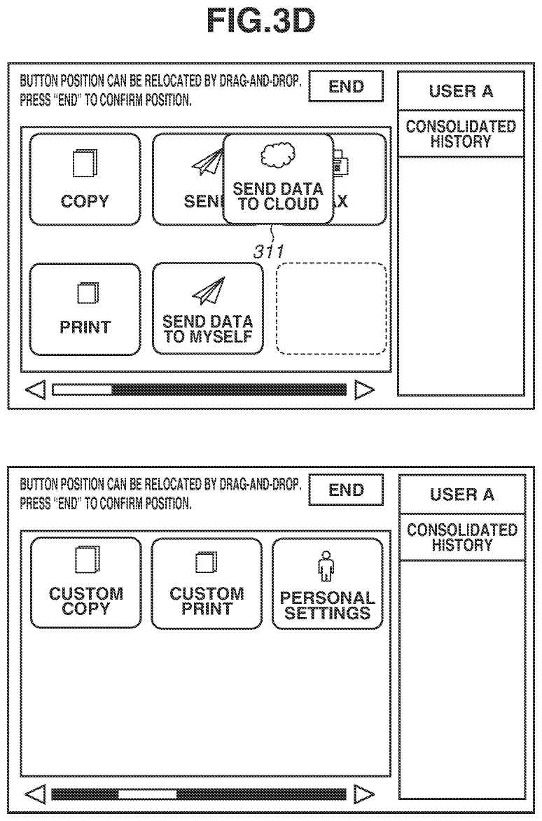

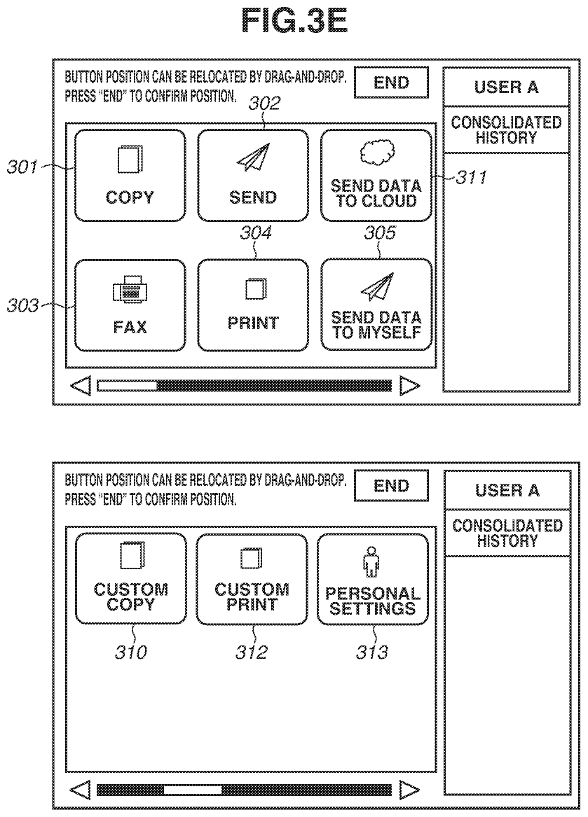

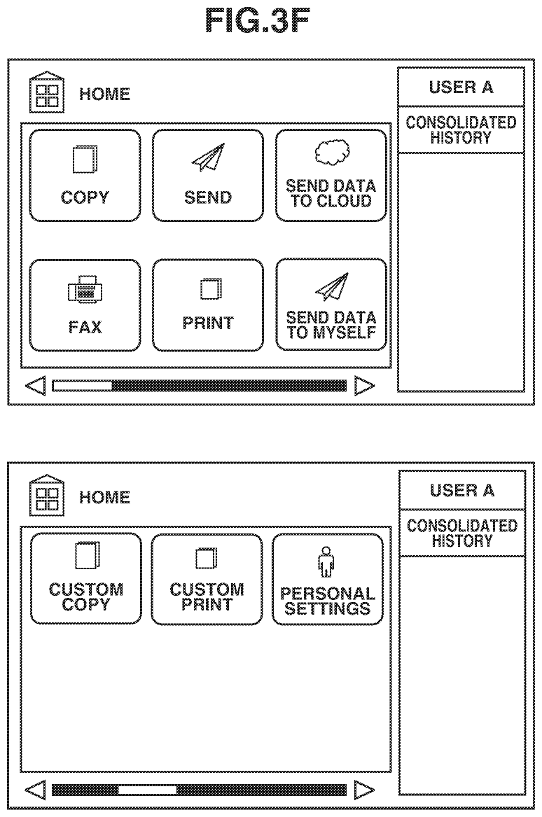

FIGS. 3A to 3F are diagrams illustrating screen transition caused by the processing for changing layout of buttons (hereinafter, called “application buttons”) indicating applications displayed on a home screen 307. An upper diagram in each of FIGS. 3A to 3F illustrates a first page of the home screen 307, and a lower diagram illustrates a page next to the first page (hereinafter, called “next page”).

The home screen 307 is a screen displayed first on the display unit 120 when power is supplied to the image processing apparatus 1, and the user can customize the application buttons displayed thereon. In addition, the home screen 307 may be displayed when the user performs an operation on a predetermined screen displayed on the display unit 120.

The application buttons are buttons (contents or icons) for executing respective functions provided by the image processing apparatus 1. For example, when an application button representing a copy function is selected by a user operation, a setting screen for executing the copy function is displayed thereon (i.e., a function corresponding to that application button is activated). In addition, each of the application buttons illustrated in FIGS. 3A to 3F may indicate another function.

In the present exemplary embodiment, screen display is described with respect to a case where an application button arranged on a next page is arranged on a first page through the operation for changing a position of the application button. However, the present disclosure is not limited thereto. For example, the present disclosure is also applicable to a case where an application button arranged on a first page is arranged on a next page through a drag-and-drop operation. For example, the operation for changing a position of the application button is a drag-and-drop operation. Further, the present disclosure is also applicable to a case where an application button arranged on another page (i.e., a third page or a page subsequent to the third page) included in the home screen 307 is arranged on a first page or a next page through a drag-and-drop operation. Furthermore, the present disclosure is also applicable to a case where a predetermined application button arranged on a position within one page is relocated to another position within the same page through a drag-and-drop operation.

The home screen 307 is described specifically with reference to FIG. 3A.

An upper diagram in FIG. 3A illustrates a display example of the first page of the home screen 307 displayed on the touch panel 200. The home screen 307 includes a menu 300 including application buttons 301 to 305 for activating applications and a blank area 323. The application buttons 301 to 305 and the blank area 323 are arranged and displayed on the menu 300 in juxtaposition. Based on the information about a log-in user, application buttons customized by the user are displayed as the application buttons 301 to 305 in layout determined by the user.

Herein, the blank area 323 is an area having a size similar to a size of the application button arranged on a background of the menu 300 (i.e., an area where the application button is arranged and overlapped with). In a visual sense, the blank area 323 is an area of the background of the menu 300, where the application button is not arranged. The background of the menu 300 is an area where the application button and the blank area 323 are arranged. Although a dotted frame indicating the blank area 323 is displayed as illustrated in the upper diagram in FIG. 3A, this frame does not have to be displayed thereon. In other words, the blank area 323 may simply be displayed in a color similar to a color (background color) of the background of the menu 300, e.g., a color similar to the color of an area between the application buttons 301 and 304 in FIG. 3A. In addition, the blank area 323 may be created when a blank area creation button for creating the blank area 323 is pressed. For example, the blank area 323 is displayed on the menu 300 when the blank area creation button displayed on the home screen 307 is pressed. Further, for example, the blank area 323 may be displayed on the menu 300 when a predetermined operation for creating the blank area 323 is performed in a button relocation phase state described below. In the button relocation phase state, the blank area 323 may be displayed in a display mode indicating the blank area 323, (e.g., a dotted frame indicating the blank area 323 is displayed), whereas in a normal state other than the button relocation phase state, the blank area 323 may simply be displayed in a color similar to the background color. Further, when application buttons one piece less than the maximum number of application buttons arrangeable on a predetermined page are arranged thereon, an area corresponding to a position where a last application button is to be lastly arranged when the maximum number of application buttons are arranged on that predetermined page may be regarded as the blank area 323. In this case, the area where application buttons have not been arranged is regarded as a background until the application buttons one piece less than the maximum number of application buttons arrangeable on a predetermined page are arranged thereon. Further, when application buttons two pieces less than the maximum number of application buttons arrangeable on a predetermined page are arranged thereon, an area corresponding to a position where a last application button is to be arranged last when the maximum number of application buttons are arranged on that predetermined page may be regarded as the blank area 323, and this condition can be changed through a setting.

A name and an icon (i.e., a diagram) indicating a function of the application button are displayed on each of the application buttons. In addition, at least one or both of the name and the icon indicating the function of the application button may be displayed thereon. In the present exemplary embodiment, the layout change processing is described by taking an application button having a predetermined function as an example. However, the present exemplary embodiment is also applicable to contents having predetermined functions in addition to the application button.

A home icon 306 is an icon which represents the home screen 307. A name of the currently logged-in user is displayed in an area 308. Each of FIGS. 3A to 3F illustrates a state where a user A is logged in. A log-out button may separately be provided, although the user can log out by pressing the area 308. One or a plurality of functions which the image processing apparatus 1 has executed in the past and a history of setting contents are automatically registered and displayed on a consolidated history 309 provided as a timeline area. The user can call executed functions and setting contents by pressing an area (not illustrated) describing the executed functions and the setting contents displayed on the consolidated history 309. When the user slides a slider bar 315 to the right or to the left, for example, another page before or after the current page is displayed on the menu 300. When the user performs an operation for displaying a page before or after the current page, the CPU 100 calls a screen (page) including predetermined application buttons from the HDD 103 according to the operation (input) and displays the screen on the menu 300. For example, the operation for displaying a page before or after the current page is any one of an operation for sliding the slider bar 315 in a predetermined direction, an operation for pressing an arrow 314 for changing the current page to a page before the current page, an operation for pressing an arrow 316 for changing the current page to a page after (next to) the current page, and an operation for flicking or scrolling the current page displayed on an area within the menu 300 to a next page or a previous page. A lower diagram in FIG. 3A illustrates an example of the screen displayed when the first page displayed on the home screen 307 is changed to a next page through the flick operation for displaying a page next to the current page. As illustrated in the lower diagram in FIG. 3A, the menu 300 which includes the application buttons 310, 311, 312, and 313 is displayed on the home screen 307.

When the user presses and holds the application button 311 illustrated in the lower diagram in FIG. 3A, a context menu 317 is displayed on the home screen 307 as illustrated in FIG. 3B. In a case where the display unit 120 does not have a touch panel function, for example, an operation (i.e., a display instruction) for displaying the context menu 317 may be input through a right-click of a pointing device.

When the user presses an open button 318 included in the context menu 317, a function corresponding to the long-pressed application button is activated. When the user presses a button relocation button 319, the home screen 307 is brought into a state (button relocation phase state) where the application buttons displayed thereon can be relocated on the home screen 307 as illustrated in FIG. 3C. In the button relocation phase state, a guidance 320 which describes that the home screen 307 is brought into a button relocation phase state and an end button 321 for confirming a button position are displayed thereon. A message indicating that the user can change the layout of the menu 300 by relocating the application buttons is displayed as the guidance 320. Messages such as “A button position can be relocated by drag-and-drop.” and “Press ‘END’ to confirm the position.” are displayed thereon. In addition, the home screen 307 that is brought into a state other than the button relocation phase state (i.e., a button relocation phase disabled state), illustrated in any one of FIGS. 3A, 3B, and 3F, is also called the home screen 307 in a normal state. In other words, the button relocation phase state refers to a state of the home screen 307 where the user is allowed to change (or relocate) the arrangement (or the position) of the application button included in the menu 300. In the button relocation phase state, the user is allowed to perform an operation for changing the arrangement of the application button included in the menu 300.

For example, in a case where the user moves a pointer in a state where a predetermined application button is being pressed by the pointer in the button relocation phase state, the predetermined application button is displayed while following the pointer. In other words, the user can drag a predetermined application button through a drag operation. Further, in a case where a predetermined application button is brought into a non-pressed state from a pressed state where the application button is pressed by a pointer, the application button is arranged and displayed at a position where the application button is released from the pressed state. In other words, the user can drop a predetermined application button through a drop operation.

In addition, a trigger which causes the home screen 307 to be brought into a button relocation phase state does not have to be a press of the button relocation button 319 displayed on the context menu 317. For example, the home screen 307 may be brought into a button relocation phase state when the user presses and holds the application button. In this case, for example, the open button 318 included in the context menu 317 may be displayed at a predetermined position on the home screen 307 instead of being included in the context menu 317.

Furthermore, the open button 318 does not always have to be displayed on the home screen 307.

FIG. 3D illustrates a state where the application button 311 displayed on the next page illustrated in the lower diagram in FIG. 3C is dragged through a drag operation and dropped into a space between the application buttons 302 and 303 displayed on the first page illustrated in the upper diagram in FIG. 3C through a drop operation. Specifically, FIG. 3D illustrates a state (dragged state) where the application button 311 which the user firstly starts dragging (i.e., the application button 311 dragged through a drag operation) is displayed while following the user's drag operation (a position (coordinates) of the user's finger). The application button 311 displayed thereon in the lower diagram in FIG. 3C is not displayed on the next page illustrated in the lower diagram in FIG. 3D because the application button 311 is relocated to the first page through the drag operation performed by the user. Specifically, the application button 312 that had been arranged next to the application button 311 on the right side thereof is arranged at a position where the application button 311 had been previously arranged, and the application button 313 that had been arranged at a leftmost position on a stage next to a stage of the application button 312 is arranged at a position where the application button 312 had been arranged previously. In other words, as illustrated in the lower diagram in FIG. 3D, each of the application buttons 312 and 313 is relocated in a direction opposite to the Z-direction by an area corresponding to one application button and arranged on the next page. The Z-direction will be described below.

FIG. 3E illustrates screen transition of the home screen 307 when the dragged application button 311 illustrated in the upper diagram in FIG. 3D is dropped into a space between the application buttons 302 and 303. Similar to the home screen 307 in FIG. 3C, the home screen 307 in FIG. 3E is also in a button relocation phase state. Through the drop operation performed on the application button 311, the application button 311 is inserted to and arranged at a position between the application buttons 302 and 303, so that each of the application buttons 303, 304, and 305 is relocated in the Z-direction by an area corresponding to one application button and arranged on the first page.

Herein, relocation in the Z-direction is described. Relocation in the Z-direction is described by taking relocation of an application button as an example. When an uppermost stage (row) and a next stage in the menu 300 are respectively called a first stage and a second stage, an application button arranged at a leftmost position of the first stage of the first page is relocated in a direction toward a rightmost position of the first stage. Further, an application button arranged at a leftmost position of the second stage is relocated in a direction toward a rightmost position of the second stage. In other words, an application button arranged on a predetermined stage is relocated in a right direction of the predetermined stage. Further, an application button arranged at a rightmost position of the first stage is relocated to a leftmost position of the second stage. In other words, an application button arranged at a rightmost position of a predetermined stage is relocated to a leftmost position of a stage next to (or under) the predetermined stage in a lower left direction. Further, an application button arranged at a rightmost position of the second stage is relocated to a leftmost position of the first stage of the next page. In other words, an application button arranged at a rightmost position of a last stage of a predetermined page is relocated to a leftmost position of the first stage of a page next to the predetermined page. Relocation of the application button is similarly executed with respect to the subsequent pages. In addition, the menu 300 displayed on the home screen 307 has the first and the second stages in one page, and each of the stages has three positions where application buttons are to be arranged. Therefore, a maximum of six application buttons can be arranged in a predetermined page, although the configuration thereof is not limited thereto. For example, a predetermined page may have two or more stages, and three or more application buttons may be arranged on a predetermined stage. With this configuration, six or more application buttons can be arranged in a predetermined page. In this configuration, an application button is similarly relocated in the Z-direction as described above.

Further, relocation in a direction opposite to the Z-direction is described. An application button arranged on a predetermined stage is relocated in a left direction of the predetermined stage. Further, an application button arranged on a leftmost position of a predetermined stage is relocated to a rightmost position of a stage ahead of the predetermined stage. Furthermore, an application button arranged at a leftmost position of an uppermost stage of a predetermined page is relocated to a rightmost position of a last stage of a page ahead of the predetermined page. Relocation of the application button in a direction opposite to the Z-direction is executed in a case where an operation for changing a position of a predetermined button is performed as illustrated in FIG. 3D. In this case, the application button subsequent to the predetermined application button in the Z-direction is arranged in an area where the predetermined application button had been arranged before the predetermined application was relocated by the above-described operation.

In the present exemplary embodiment, as illustrated in FIG. 3E, in a case where a predetermined application button is dragged through a drag operation and inserted into a position between a first application button and a second application button through a drop operation, one or a plurality of application buttons arranged subsequent to the second application button in the Z-direction is relocated in the Z-direction.

In the first page illustrated in the upper diagram in FIG. 3E, an application button 305 is arranged at a position of the blank area 323 next to the application button 305 on the right side thereof, displayed on the first page illustrated in the upper diagram in FIG. 3C. Further, similar to the state illustrated in each of FIGS. 3A to 3D, the application button 310 is arranged and displayed at a leftmost position of the first stage of the next page illustrated in the lower diagram in FIG. 3E. In other words, the blank area 323 is regarded as an unnecessary area, and is not included in the menu 300. Further, a direction the application button is to be relocated does not have to be the Z-direction.

FIG. 3F illustrates the home screen 307 in a normal state displayed when the user disables the button relocation phase state by pressing the end button 321 in a state (button relocation state) illustrated in FIG. 3E.

As illustrated in FIGS. 3A to 3F, an area other than an area where application buttons included in the menu 300 of the home screen 307 are arranged, i.e., the blank area 323, is regarded as an unnecessary area. For example, in a case where a predetermined application button displayed on a page other than a predetermined page is relocated to the predetermined page through the drag-and-drop operation, a blank area 323 is not displayed on the predetermined page for the area corresponding to the predetermined application buttons arranged on the predetermined page. As described above, in a case where a predetermined application button displayed on a page other than a predetermined page is arranged on the predetermined page through a drag-and-drop operation, application buttons corresponding to the maximum number of application buttons arrangeable on the predetermined page are displayed on the predetermined page, so that the blank area 323 is not included in the menu 300 in that predetermined page.

However, there is a case where the user wishes to utilize the blank area 323 included in the predetermined page. For example, in a case where an application button group 1 which includes a plurality of application buttons having similar functions and an application button group 2 which includes a plurality of application buttons having functions different from those of the application button group 1 are displayed thereon, the user can display the application button groups 1 and 2 in a distinguishable manner by inserting a blank area 323 between the application button groups 1 and 2.

Therefore, in the present exemplary embodiment, in order to allow the user to utilize the blank area 323, in a case where the information processing apparatus accepts an operation for relocating an application button, an area having a size similar to a size of an area indicating the application button is relocated and displayed as the blank area 323 (hereinafter, expressed as “display a blank area 323). Specifically, in a case where a predetermined application button is dragged through a drag operation and inserted into a space between the first application button and the second application button (or the blank area 323) through a drop operation, not only one or a plurality of application buttons arranged subsequent to the second application button in the Z-direction but also the blank area 323 are controlled and relocated in the Z-direction. In other words, when the home screen 307 is in a button relocation phase state, the blank area 323 is also regarded as a button area and relocated in a same way as the application buttons. In this way, the blank area 323 can be displayed thereon, so that convenience of the user can be improved. In addition, the blank area 323 is a transparent area within the menu 300, where an application button is not arranged, and a color thereof is similar to a color (background color) of an area other than the blank area 323, e.g., an area between the application buttons 301 and 304 in FIG. 3A. However, a frame or a color can be applied to the blank area 323, and any display mode which enables the user to recognize the blank area 323 can be employed.

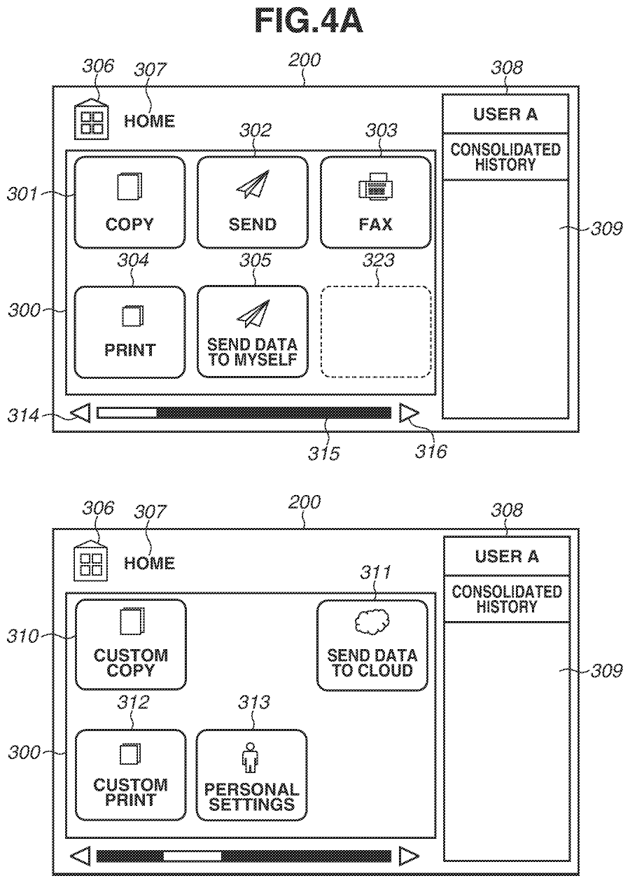

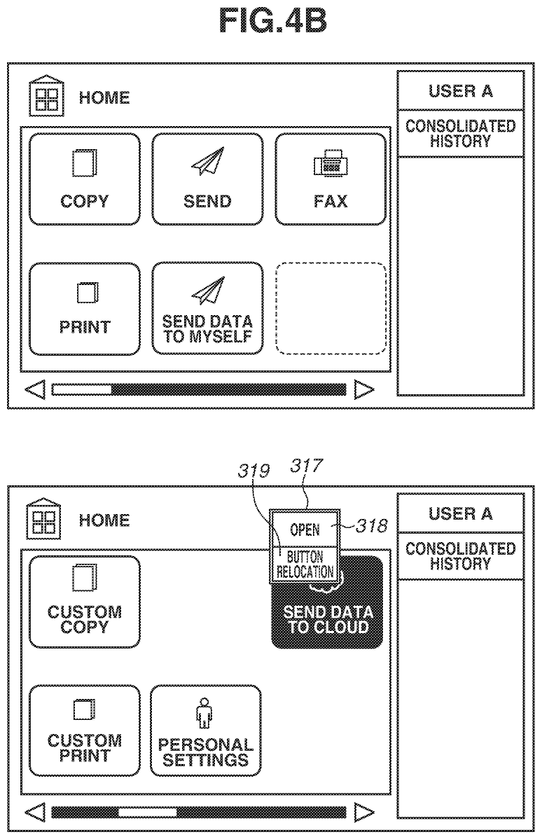

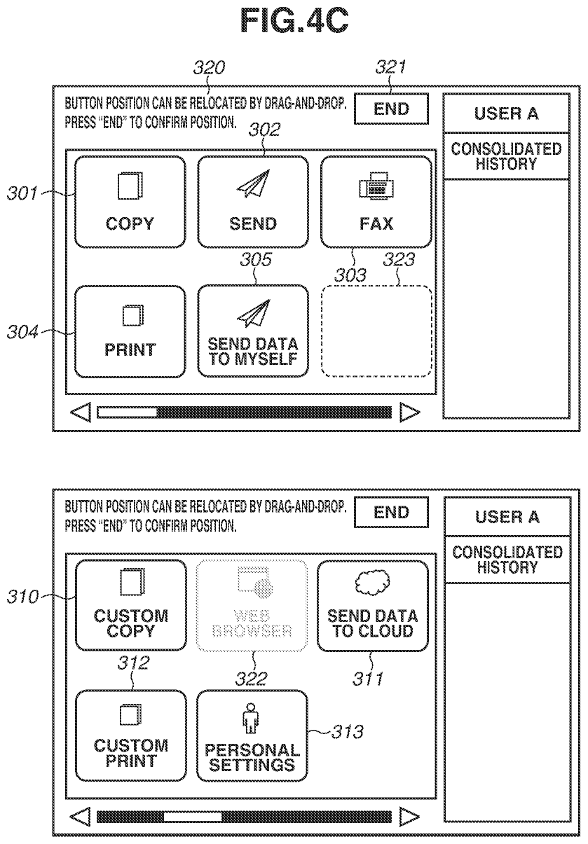

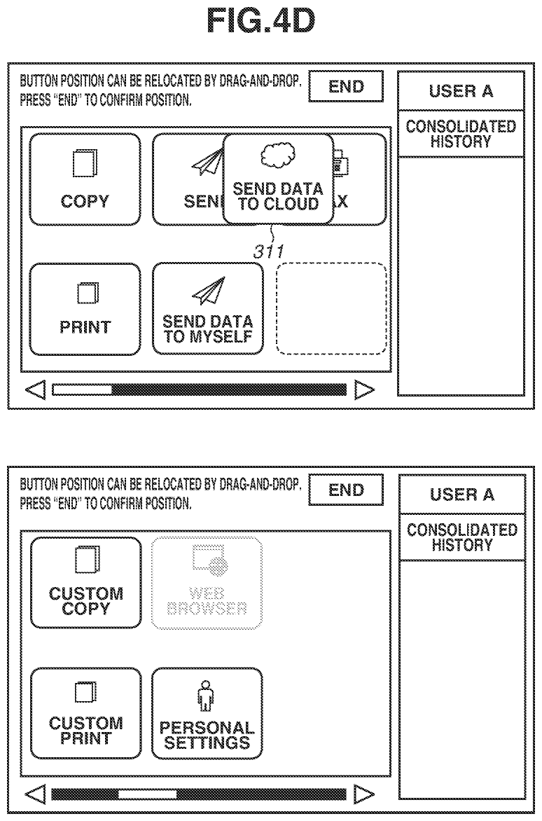

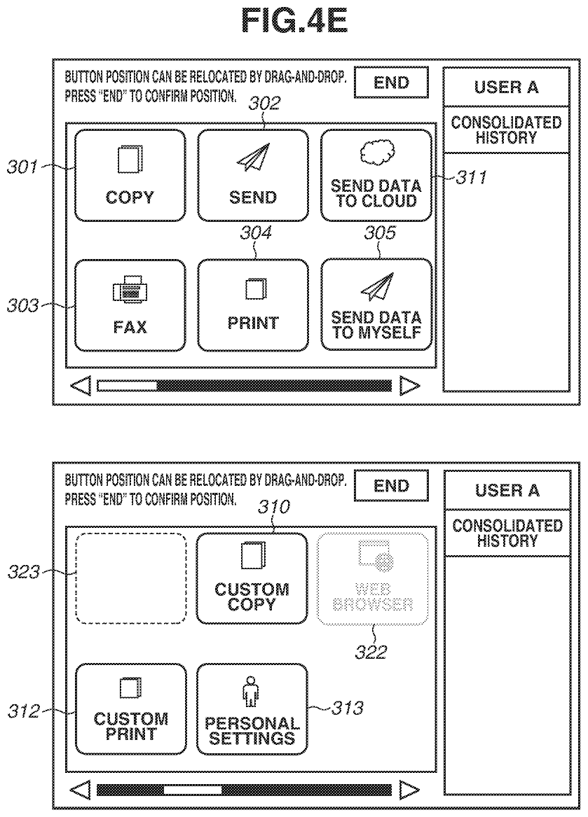

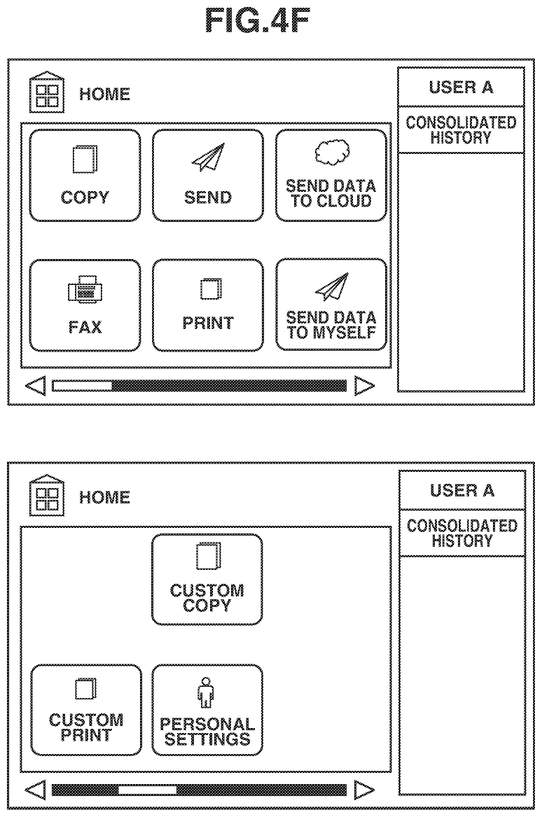

FIGS. 4A to 4F are diagrams illustrating screen transition caused by the processing for changing the layout of application buttons displayed on the home screen 307. A upper diagram in each of FIGS. 4A to 4F illustrates a first page of the home screen 307, and a lower diagram illustrates a page next to the first page (hereinafter, called “next page”). Descriptions of FIGS. 4A to 4F similar to descriptions of FIGS. 3A to 3F are omitted.

FIG. 4A illustrates an example of the screen displayed when the first page of the home screen 307 is changed to a next page. As illustrated in the lower diagram in FIG. 4A, the menu 300 includes the application buttons 310, 311, 312, 313 and the blank area 323 is displayed on the next page of the home screen 307. Herein, the blank area 323 refers to an area between the application buttons 310 and 311.

In the present exemplary embodiment, the user is allowed to perform a setting for bringing a predetermined application button into a non-display state through a setting screen (not illustrated) displayed based on a predetermined operation performed on the display unit 120. The application button with a non-display setting is not displayed on the home screen 307 in a state other than the button relocation phase state (i.e., a normal state), and is displayed on the home screen 307 in the button relocation phase state. Further, it is assumed that an application button 322 brought into a non-display state through the non-display setting is actually arranged in the blank area 323 between the application buttons 310 and 311 in the lower diagram in FIG. 4A.

FIG. 4C illustrates the home screen 307 in a button relocation phase, and the application button 322 with a non-display setting is displayed on the screen illustrated in the lower diagram. In other words, a blank area such as the blank area 323 illustrated in the upper diagram in FIG. 4C (i.e., a true blank area) and a blank area corresponding to an application button with a non-display setting (i.e., a blank area with a non-display setting) are provided as the blank areas. A name and an icon for indicating a function of the predetermined application button are not displayed on the true blank area 323 even when the home screen 307 is brought into a button relocation phase state. In other words, the true blank area 323 is an area within the menu 300 which does not correspond to a predetermined application, and an application button is not displayed thereon. On the other hand, when the home screen 307 is brought into a button relocation phase state, a name and an icon for indicating a function of the predetermined application button are displayed on the blank area 323 with a non-display setting, in a display mode different from a display mode of the application button without a non-display setting.

For example, in the same manner as the application button 322 illustrated in the lower diagram in FIG. 4C, a name and an icon for indicating a function of the application button 322 with a non-display setting and a frame which surrounds the name and the icon are displayed translucently.

FIG. 4D illustrates a state where the application button 311 displayed on the next page illustrated in the lower diagram in FIG. 4C is dragged through a drag operation and dropped into a space between the application buttons 302 and 303 displayed on the first page illustrated in the upper diagram in FIG. 4C through a drop operation. Specifically, FIG. 4D illustrates a state (dragged state) where the application button 311 which the user firstly starts dragging (i.e., the application button 311 dragged through a drag operation) is displayed while following the user's drag operation (a position (coordinates) of the user's finger). The application button 311 displayed thereon in the lower diagram in FIG. 4C is not displayed on the next page illustrated in the lower diagram in FIG. 4D because the application button 311 is relocated to the first page through the drag operation performed by the user. As illustrated in the lower diagram in FIG. 4D, another application button is not arranged at a position where the application button 311 is arranged before the operation for relocating a position of the application button 311 is performed. However, another application button may be arranged at the position of the application button 311 based on a drag operation performed on the application button 311. Specifically, the application button 312 arranged at a leftmost position on a stage next to a stage of the application button 311 may be arranged at a position where the application button 311 is previously arranged, and an application button 313 may be arranged at a position where the application button 312 is arranged previously. In other words, each of the application buttons 312 and 313 is relocated in a direction opposite to the Z-direction by an area corresponding to one application button and arranged on the next page.

FIG. 4E illustrates screen transition of the home screen 307 when the dragged application button 311 illustrated in the upper diagram in FIG. 4D is dropped into a space between the application buttons 302 and 303. Similar to the home screen 307 in FIG. 4C, the home screen 307 in FIG. 4E is also in a button relocation phase state. Through the drop operation performed on the application button 311, the application button 311 is inserted to and arranged at a position between the application buttons 302 and 303, so that each of the application buttons 303, 304, 305, the blank area 323, the application button 310, a blank area 323 with a non-display setting corresponding to the application button 322, and the application buttons 312 and 313 is relocated in the Z-direction by an area corresponding to one application button and arranged thereon.

Screen transition is described more specifically. The blank area 323 on the right side of the application button 305, displayed on the first page illustrated in the upper diagram in FIG. 4C, is arranged and displayed at a leftmost position of the first stage of the next page illustrated in a lower diagram in FIG. 4E. In other words, instead of making the application button 310 be arranged at a leftmost position of the first stage of the next page by considering the blank area 323 as an unnecessary area, the blank area 323 which does not correspond to the application button is also considered as one button area and relocated in the Z-direction.

FIG. 4F illustrates the home screen 307 in a normal state displayed when the user disables the button relocation phase state by pressing the end button 321 in a state (button relocation state) illustrated in FIG. 4E. Because a button relocation phase state is ended when the user presses the end button 321, a frame of the application button 322 which includes the name and the icon for indicating the function of the application button 322 corresponding to the blank area 323 with a non-display setting, is brought into a non-display state.

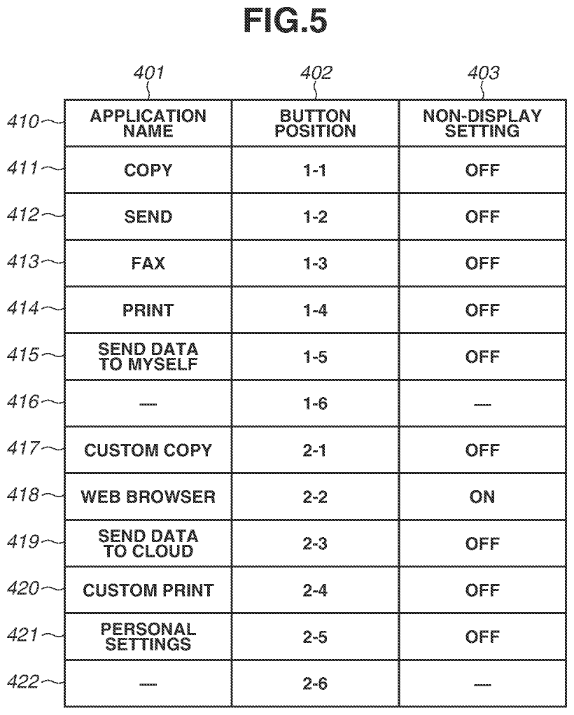

FIG. 5 is an information table illustrating a display position of each of the application buttons displayed on the home screen 307.

An information table 410 includes pieces of information about an application name 401, a button position 402, and a non-display setting 403 for describing whether an application is displayed on the home screen 307. The button position 402 describes a display position of a corresponding application name 401, and a left numeral indicates which row a predetermined application button is arranged when counted from the top of the home screen 307, whereas a right numeral indicates which column the predetermined application button is arranged when counted from the left side of the home screen 307. In other words, these numerals indicate what position the predetermined application button is arranged when counted from the left side of a predetermined stage. For example, “1-1” indicates a position of the application button 301 having the application name “Copy” in FIG. 3A. The non-display setting 403 describes information indicating whether an application button is to be displayed on the home screen 307. This information is set by the user or the manager through a setting screen included in a setting icon (not illustrated) displayed on the home screen 307. When the CPU 100 displays the home screen 307, the CPU 100 refers to the information table 410 to determine whether to display a predetermined application button.

If “ON” is set to the non-display setting 403, the CPU 100 displays a blank space on the home screen 307 instead of displaying the application button of the corresponding application even when the corresponding application is installed. When the home screen 307 is in a button relocation phase state, the application button of the corresponding application is displayed translucently. If “OFF” is set to the non-display setting 403, the CPU 100 displays the application button of the corresponding application on the home screen 307. Further, as in the case of information 416, in a case where information has empty spaces for the application name 401 and the non-display setting 403, a corresponding application does not exist in that position. Therefore, an application button is not arranged and displayed at a button position 1-6.

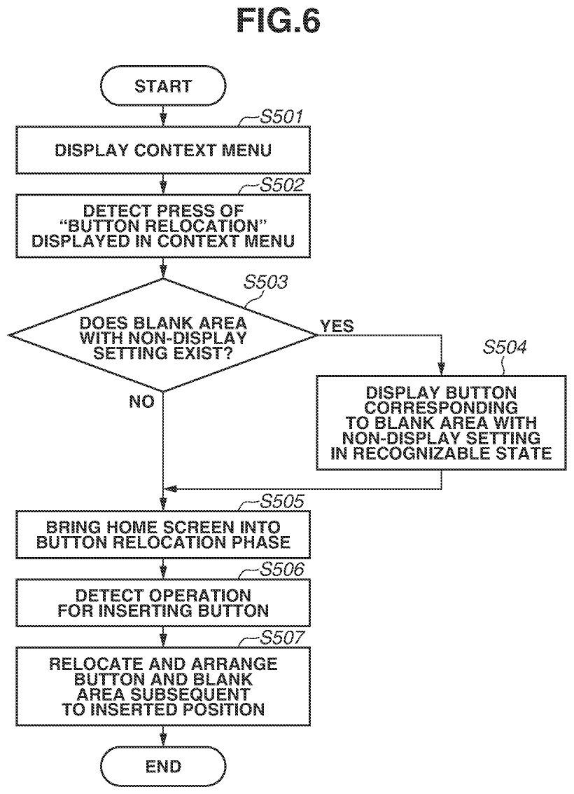

FIG. 6 is a flowchart illustrating the processing for changing the layout of the application button displayed on the home screen 307. A program according to the present exemplary embodiment is stored in the HDD 103 of the image processing apparatus 1, read to the RAM 102, and executed by the CPU 100.

The processing illustrated in this flowchart is started when the CPU 100 detects the above-described operation for displaying the context menu 317 performed on the application button included in the menu 300 of the home screen 307.

In step S501, the CPU 100 displays the context menu 317.

In step S502, the CPU 100 detects that the button relocation button 319 displayed on the context menu 317 is pressed.

In step S503, the CPU 100 determines whether a blank area 323 with a non-display setting is included in the menu 300 of the home screen 307. In a case where a determination result in step S503 is “YES” (YES in step S503), the processing proceeds to step S504. In a case where a determination result in step S503 is “NO” (NO in step S503), the processing proceeds to step S505.

In step S504, the CPU 100 executes processing for displaying the blank area 323 with a non-display setting in a display mode different from a display mode of the application button without a non-display setting. For example, in the same manner as the application button 322 illustrated in the lower diagram in FIG. 4C, a name and an icon for indicating a function of the application button 322 with a non-display setting and a frame which surrounds the name and the icon are displayed translucently.

In step S505, the CPU 100 brings the home screen 307 into a button relocation phase state in which the user is allowed to change (or relocate) the arrangement (or the position) of the application button included in the menu 300.

In step S506, the CPU 100 detects the operation for changing a position of a predetermined application button. Specifically, the CPU 100 detects that a predetermined application button is selected and dragged through a drag operation and dropped into a position different from the current position through a drop operation. For example, the CPU 100 detects a drag-and-drop operation for inserting the predetermined application button into a space between the first application button and the second application button (or a blank area 323).

In step S507, the CPU 100 relocates each of the application button and the blank area 323 subsequent to the position of the above-described inserted predetermined application button in the Z-direction by an area corresponding to the predetermined application button in the Z-direction, and arranges the application button and the blank area 323 thereon. Then, the CPU 100 ends the processing described in this flowchart.

Further, either of these steps S503 and S505 of this flowchart can be executed first.

In the above-described exemplary embodiment, in order to allow the user to utilize the blank area 323, in a case where the information processing apparatus accepts an operation for relocating an application button, an area having a size similar to a size of an area indicating the application button is relocated and displayed as the blank area 323. Specifically, in a case where a predetermined application button is dragged through a drag operation and inserted into a space between the first application button and the second application button (or the blank area 323) through a drop operation, not only one or a plurality of application buttons arranged subsequent to the second application button in the Z-direction but also the blank area 323 are controlled and relocated in the Z-direction. In other words, when the home screen 307 is in a button relocation phase state, the blank area 323 is also regarded as a button area and relocated in a same way as the application buttons. In this way, the blank area 323 can be displayed thereon, so that convenience of the user can be improved in changing of layout of the application button.

In the first exemplary embodiment, in order to allow the user to utilize the blank area 323 included in the menu 300 of the home screen 307, in a case where the information processing apparatus accepts an operation for relocating an application button, an area having a size similar to a size of an area indicating the application button is relocated and displayed as the blank area 323.

In a second exemplary embodiment, the information processing apparatus can also accept an operation for relocating the blank area 323 in addition to executing the processing described in the first exemplary embodiment. Therefore, screen transition is described with respect to a case where the operation for relocating the blank area 323 is performed.

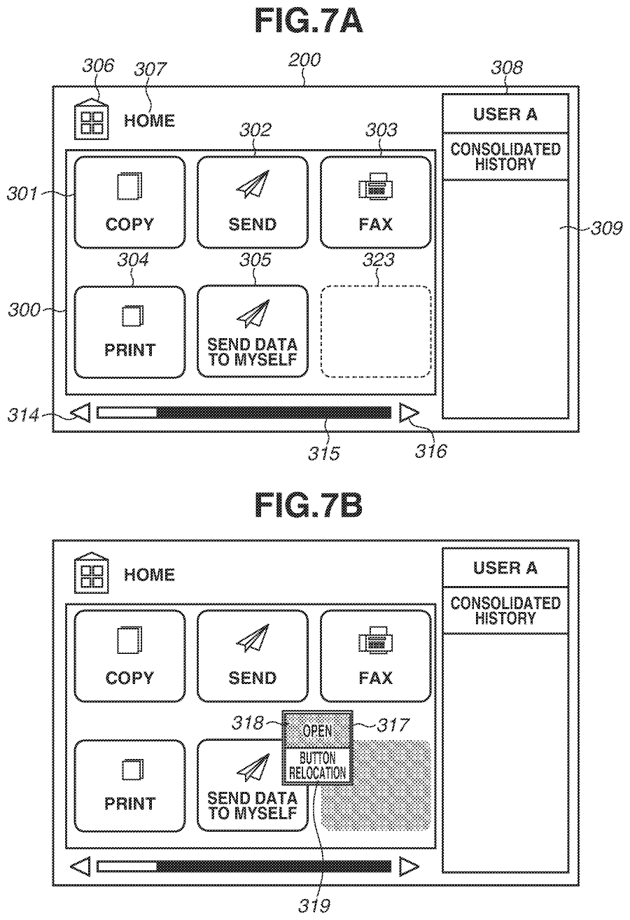

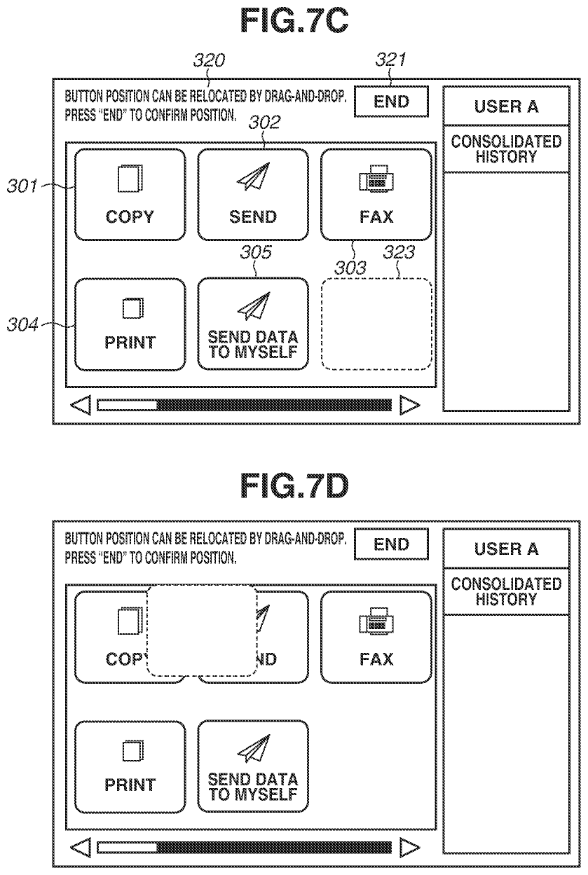

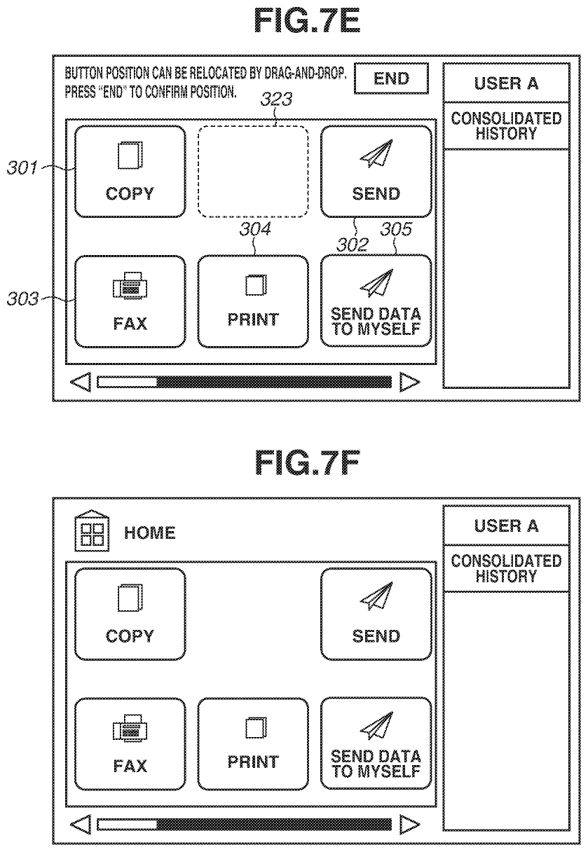

FIGS. 7A to 7F are diagrams illustrating screen transition caused by the operation for relocating the blank area 323 included in the menu 300 of the home screen 307.

The operation for relocating the blank area 323 in FIGS. 7A to 7F corresponds to the operation for relocating the application button 311 in FIGS. 3A to 3F or FIGS. 4A to 4F, so that FIGS. 7A to 7F illustrate screens similar to those illustrated in FIGS. 3A to 3F or FIGS. 4A to 4F. In FIGS. 7A to 7F, screen transition is described with respect to a case where the operation for relocating the true blank area 323 is performed. However, similar screen transition is also applicable to a case where the operation for relocating the blank area 323 corresponding to the application button 322 with a non-display setting is performed.

When the user presses and holds the blank area 323 illustrated in FIG. 7A, a context menu 317 is displayed on the home screen 307 as illustrated in FIG. 7B. In a case where the display unit 120 does not have a touch panel function, for example, an operation (i.e., a display instruction) for displaying the context menu 317 may be input through a right-click of a pointing device. In a case where an operation for displaying the context menu 317 is performed on the blank area 323, the blank area 323 may be displayed in a recognizable state. For example, as illustrated in FIG. 7B, the blank area 323 may be displayed on the menu 300, in a color different from a color of an area different from the blank area 323, i.e., a background area, where application buttons are not displayed. Further, a frame line indicating a frame of the blank area 323 may be displayed thereon.

When the user presses an open button 318 included in the context menu 317, a function corresponding to the long-pressed blank area 323 is activated. When the user presses a button relocation button 319, the home screen 307 is brought into a state (button relocation phase state) where the application buttons displayed thereon can be relocated on the home screen 307 as illustrated in FIG. 7C. The open button 318 is displayed when the user performs an operation (a long-press operation) on the blank area 323 with a non-display setting in order to relocate that blank area 323 with a non-display setting. In other words, a function of the application corresponding to the blank area 323 with a non-display setting is activated. In a case where the user performs the operation on the true blank area 323 in order to relocate the true blank area 323, the information processing apparatus displays only the button relocation button 319 without displaying the open button 318.

In the button relocation phase state, a guidance 320 indicating that the home screen is brought into a button relocation phase state and an end button 321 for confirming a button position are displayed thereon. A message describing that the user can change the layout of the menu 300 by relocating the application buttons is displayed as the guidance 320. Messages such as “A button position can be relocated by drag-and-drop.” and “Press “END” to confirm the position.” are displayed thereon. In addition, the home screen 307 that is brought into a state other than the button relocation phase state (i.e., a button relocation phase disabled state), illustrated in any one of FIGS. 7A, 7B, and 7F, is also called the home screen 307 in a normal state. In other words, the button relocation phase state refers to a state of the home screen 307 where the user is allowed to change (or relocate) the arrangement (or the position) of the application button or the blank area 323 included in the menu 300. In the button relocation phase state, the user is allowed to perform the operation for changing the arrangement of the application button or the blank area 323 included in the menu 300. For example, in a case where the user moves a pointer in a state where the predetermined application button or the blank area 323 is being pressed by the pointer in the button relocation phase state, the predetermined application button or the blank area 323 is displayed while following the pointer. In other words, the user can drag the predetermined application button or the blank area 323 through a drag operation. Further, in a case where the predetermined application button or the blank area 323 is brought into a non-pressed state from a pressed state where the application button or the blank area 323 is pressed by a pointer, the application button or the blank area 323 is arranged and displayed at a position where the predetermined application button or the blank area 323 is released from the pressed state. In other words, the user can drop the predetermined application button or the blank area 323 through a drop operation.

FIG. 7D illustrates a state where the blank area 323 displayed on the first page of the home screen 307 illustrated in the diagram in FIG. 7C is dragged through a drag operation and dropped into a space between the application buttons 302 and 303 displayed on the first page through a drop operation. Specifically, FIG. 7D illustrates a state (dragged state) where the blank area 323 which the user firstly starts dragging (i.e., the blank area 323 dragged through a drag operation) is displayed while following the user's drag operation (a position (coordinates) of the user's finger). In the button relocation phase, the blank area 323 may be displayed in a recognizable state. For example, a frame line indicating a frame of the blank area 323 may be displayed, or a color may be added thereto. Further, in a case where the blank area 323 is displayed in a recognizable state when a display instruction of the context menu 317 is input to the blank area 323, the home screen 307 may be brought into a button relocation phase state while maintaining the recognizable state of the blank area 323.

FIG. 7E illustrates screen transition of the home screen 307 when the dragged blank area 323 illustrated in FIG. 7D is dropped into a space between the application buttons 302 and 303. Similar to the home screen 307 in FIG. 7C, the home screen 307 in FIG. 7E is also in a button relocation phase state. Through the drop operation performed on the blank area 323, the blank area 323 is inserted to and arranged at a position between the application buttons 302 and 303, so that each of the application buttons 303, 304, and 305 is relocated in the Z-direction by an area corresponding to one application button and arranged on the first page.

FIG. 7F illustrates the home screen 307 in a normal state displayed when the user disables the button relocation phase state by pressing the end button 321 in a state (button relocation state) illustrated in FIG. 7E. Further, in a case where the blank area 323 is displayed in a recognizable state when a display instruction of the context menu 317 is input to the blank area 323 or when the home screen 307 is brought into a button relocation phase state, the blank area 323 is displayed in a transparent state at a timing when the end button 321 is pressed. In other words, the blank area 323 is displayed on the menu 300, in a color similar to a color of an area different from the blank area 323, i.e., a background area, where application buttons are not displayed.

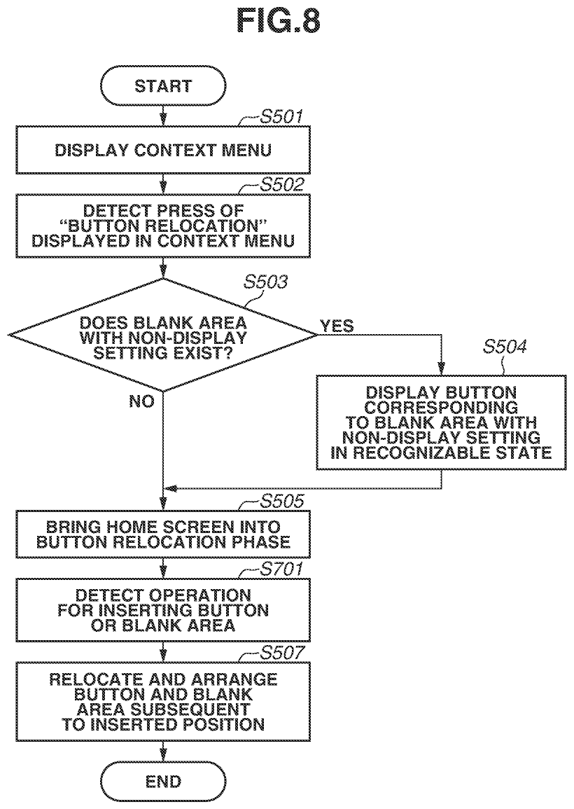

FIG. 8 is a flowchart illustrating the processing for changing the layout of the application button displayed on the home screen 307. A program according to the present exemplary embodiment is stored in the HDD 103 of the image processing apparatus 1, read to the RAM 102, and executed by the CPU 100.

The processing illustrated in this flowchart is started when the CPU 100 detects the above-described operation for displaying the context menu 317 performed on the application button or the blank area 323 included in the menu 300 of the home screen 307.

The processing in steps S501 to S505 and S507 is similar to the processing in steps S501 to S505 and S507 in FIG. 6.

In step S701, the CPU 100 detects an operation for changing a position of a predetermined application button or the blank area 323. Specifically, the CPU 100 detects that a predetermined application button or the blank area 323 is selected and dragged through a drag operation and dropped into a position different from the current position through a drop operation. For example, the CPU 100 detects a drag-and-drop operation for inserting a predetermined application button or the blank area 323 into a space between the first application button and the second application button (or the blank area 323).

According to the present exemplary embodiment, the information processing apparatus can accept the operation for relocating a blank area in addition to the operation for relocating an application button. With this configuration, operability of the blank area is improved, so that convenience of the user can be improved further.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-025858, filed Feb. 22, 2023, which is hereby incorporated by reference herein in its entirety.

What is claimed is:

1. An information processing apparatus having a plurality of functions, comprising:
a display unit configured to display a predetermined area where a software key indicating any one of the plurality of functions is arrangeable;
an acceptance unit configured to accept a first operation for selecting the predetermined area where the software key is not arranged and a second operation for selecting a destination of the predetermined area where the software key is not arranged and selected through the first operation; and
a relocation unit configured to relocate the predetermined area where the software key is not arranged and selected through the first operation, to the destination selected through the second operation.

2. The information processing apparatus according to claim 1, wherein the predetermined area is an area having a size similar to a size of the software key indicating a predetermined function.

3. The information processing apparatus according to claim 1, wherein the predetermined area is an area having a shape similar to a shape of the software key indicating a predetermined function.

4. The information processing apparatus according to claim 1, wherein, in a case where the relocation unit relocates the predetermined area where the software key is not arranged and selected through the first operation, to the destination selected through the second operation, a predetermined area where a software key is not arranged, which is different from the relocated predetermined area, and a predetermined area where a software key is arranged are also relocated.

5. The information processing apparatus according to claim 1, wherein the acceptance unit accepts the first operation and the second operation in a mode for relocating the predetermined area.

6. The information processing apparatus according to claim 5, wherein, in the mode for relocating the predetermined area, the predetermined area where the software key is arranged in a non-display state is displayed in a state indicating that the software key is arranged but not displayed.

7. The information processing apparatus according to claim 6, wherein the state indicating that the software key is arranged but not displayed is a translucent state.

8. The information processing apparatus according to claim 1, wherein the predetermined area is displayed on a home screen of the information processing apparatus.

9. The information processing apparatus according to claim 1, wherein the acceptance unit further accepts a third operation for selecting the predetermined area where the software key is arranged and a fourth operation for selecting a destination of the predetermined area where the software key is arranged and selected through the third operation.

10. The information processing apparatus according to claim 9, wherein the relocation unit further relocates the predetermined area where the software key is arranged and selected through the third operation, to the destination selected through the fourth operation.

11. The information processing apparatus according to claim 1, wherein the acceptance unit further accepts a fifth operation for selecting the predetermined area where the software key is arranged in a non-display state and a sixth operation for selecting a destination of the predetermined area where the software key is arranged in a non-display state and selected through the fifth operation.

12. The information processing apparatus according to claim 11, wherein the relocation unit further relocates the predetermined area where the software key is arranged in a non-display state and selected through the fifth operation, to the destination selected through the sixth operation.

13. The information processing apparatus according to claim 1, wherein the first operation is a touch operation, and the second operation is a drag-and-drop operation.

14. The information processing apparatus according to claim 9, wherein the third operation is a touch operation, and the fourth operation is a drag-and-drop operation.

15. The information processing apparatus according to claim 11, wherein the fifth operation is a touch operation, and the sixth operation is a drag-and-drop operation.

16. The information processing apparatus according to claim 1, wherein the information processing apparatus is a printer.

17. A control method of an information processing apparatus having a plurality of functions, the control method comprising:
displaying a predetermined area where a software key indicating any one of the plurality of functions is arrangeable;
accepting a first operation for selecting the predetermined area where the software key is not arranged and a second operation for selecting a destination of the predetermined area where the software key is not arranged and selected through the first operation; and
relocating the predetermined area where the software key is not arranged, selected through the first operation, to the destination selected through the second operation.

18. A non-transitory computer-readable storage medium storing a program for causing a computer of an information processing apparatus having a plurality of functions to execute a method, the method comprising:
displaying a predetermined area where a software key indicating any one of the plurality of functions is arrangeable;
accepting a first operation for selecting the predetermined area where the software key is not arranged and a second operation for selecting a destination of the predetermined area where the software key is not arranged and selected through the first operation; and
relocating the predetermined area where the software key is not arranged and selected through the first operation, to the destination selected through the second operation.
